(19) United States
(12) Patent Application Publication
(10) Pub. No.: US 2016/0224230 A1
(43) Pub. Date: Aug. 4, 2016

(54) SETTING INPUT MEANS OF INJECTION MOLDING MACHINE

(71) Applicant: FANUC Corporation, Yamanashi (JP)

(72) Inventors: Haruyuki FUJITA, Yamanashi (JP); Nobuto TAKEDA, Yamanashi (JP)

(21) Appl. No.: 15/012,234

(22) Filed: Feb. 1, 2016

(30) Foreign Application Priority Data
Feb. 2, 2015 (JP) 2015-018259

(51) Int. Cl. G06F 3/0484; G06F 3/0482; G06F 3/0488; B29C 45/17

(52) U.S. Cl. CPC G06F 3/04847; B29C 45/1774; G06F 3/0482; G06F 3/04842; G06F 3/0488; B29C 2945/76939

(57) ABSTRACT

A setting input means of an injection molding machine is provided with a plural setting item selection means for selecting a plurality of setting items and a batch input means capable of collectively inputting one and the same setting state to the plurality of setting items. With this arrangement, the one and the same setting state can be collectively input to the plurality of optional setting items, so that operators' operational errors and the number of man-hours can be reduced.

### BACKGROUND OF THE INVENTION

1. Field of the Invention

The present invention relates to a setting input means of an injection molding machine, and more particularly, to a setting input means of a display device with a touch panel.

2. Description of the Related Art

An injection molding machine is used to manufacture molded articles from a resin, such as a plastic, in various processes, including mold closing, mold clamping, injection, dwelling, metering, mold opening, and ejection processes. In molding the molded articles, it is important to set the injection speed, injection pressure, and times, temperatures, and the like for mold closing and mold clamping, in these molding processes.

In the injection molding machine of this type, setting items are set in such a manner that items to be changed are selected and input through an input means such as a ten-key pad. Further, data such as pressures, speeds, and positions, indicative of the respective behaviors of the molding processes, are displayed on the screen of a display device. In some cases, a touch panel is disposed on the display device so that it can be operated to change the setting of molding conditions.

Basically, the setting of the molding conditions is individual setting. However, there are a very large number of setting items for the molding conditions of an injection molding machine, and an operator is expected to input and set the entire number of setting items for the molding conditions. Thus, the operation is time-consuming and operational errors may occur in some cases. It is desirable, therefore, to enable collective or batch input to a plurality of setting items.

Japanese Patent Application Laid-Open No. 2001-47487 discloses a technique in which temperatures are individually set in changed-temperature setters and arithmetic value setters in setting heating cylinder temperatures in an injection molding machine. By pressing an execute key, according to this technique, calculated values from the changed-temperature setters and the arithmetic value setters are collectively set to set control temperatures.

Japanese Patent Application Laid-Open No. 2010-60905 discloses a technique in which a register means is provided for registering a plurality of parameters detected for the detection of selection operation as selection parameters, in setting parameters on a touch panel, and the values of the selection parameters registered by the register means are set at a time. In the prior art technique for individually setting the molding conditions, as described above, the operator must input and set the entire number of setting items for the molding conditions, so that the operation is time-consuming and operational errors may sometimes occur.

The technique disclosed in Japanese Patent Application Laid-Open No. 2001-47487 is a technique for collectively setting a plurality of items using a plurality of temperature setters together. According to this technique, those items which can be collectively set are restricted to specific items in the same category and cannot be freely selected. In some cases, therefore, operators cannot easily set their desired items.

Although the technique disclosed in Japanese Patent Application Laid-Open No. 2010-60905 is related to a parameter setting method, it is different from a prerequisite technique for a display device of an injection molding machine. According to this technique, moreover, the parameters to be set at a time must be registered in advance in the register means, so that they must be registered again in the register means in case of change or addition. Consequently, the change or addition of the parameters may require troublesome and time-consuming operation.

### SUMMARY OF THE INVENTION

Accordingly, the object of the present invention is to provide an injection setting input means of an injection molding machine, capable of reducing operators' operational errors and the number of man-hours.

A setting input means of an injection molding machine according to the present invention, which sets and inputs setting items by means of a touch panel, comprises a plural setting item selection means for selecting a plurality of setting items and a batch input means capable of collectively inputting one and the same setting state to the plurality of setting items selected by the plural setting item selection means.

Thus, the one and the same setting state can be collectively input to the plurality of optional setting items, so that operators' operational errors and the number of man-hours can be reduced.

The plural setting item selection means may be configured to select the plurality of setting items by designating a range including the plurality of setting items. Thus, the plurality of setting items can be selected by a simple operation.

The setting input means may further comprise a setting item selection button, and the plural setting item selection means may be configured to select, as the plurality of setting items, setting items selected by operating the setting item selection button. Thus, those separate selection items which cannot easily be selected by only selecting the range can be selected as the plurality of selection items. Further, the plurality of setting items can be selected by a simple operation.

The one and the same setting state may be one value, one condition, and/or one input propriety state.

The setting input means may comprise a selection means configured to select the one value, the one condition, and/or the one input propriety state as the one and the same setting state.

According to the present invention, operators' operational errors and the number of man-hours can be reduced in a setting input means of an injection molding machine.

### BRIEF DESCRIPTION OF THE DRAWINGS

The above and other objects and features of the present invention will be obvious from the ensuing description of embodiments with reference to the accompanying drawings, in which:

FIG. 1 is a diagram showing a setting item selection method according to an embodiment of the present invention;

FIG. 2 is a diagram showing the setting item selection method according to the embodiment of the invention;

FIG. 3 is a diagram showing a setting item selection method according to another embodiment of the invention;

FIG. 4 is a diagram showing the setting item selection method according to the embodiment of the invention;

FIG. 5 is a diagram showing a value setting method according to the embodiment of the invention;

FIG. 6 is a diagram showing a condition setting method according to the embodiment of the invention; and

FIG. 7 is a diagram showing an input propriety setting method according to the embodiment of the invention.

### DETAILED DESCRIPTION OF THE PREFERRED EMBODIMENTS

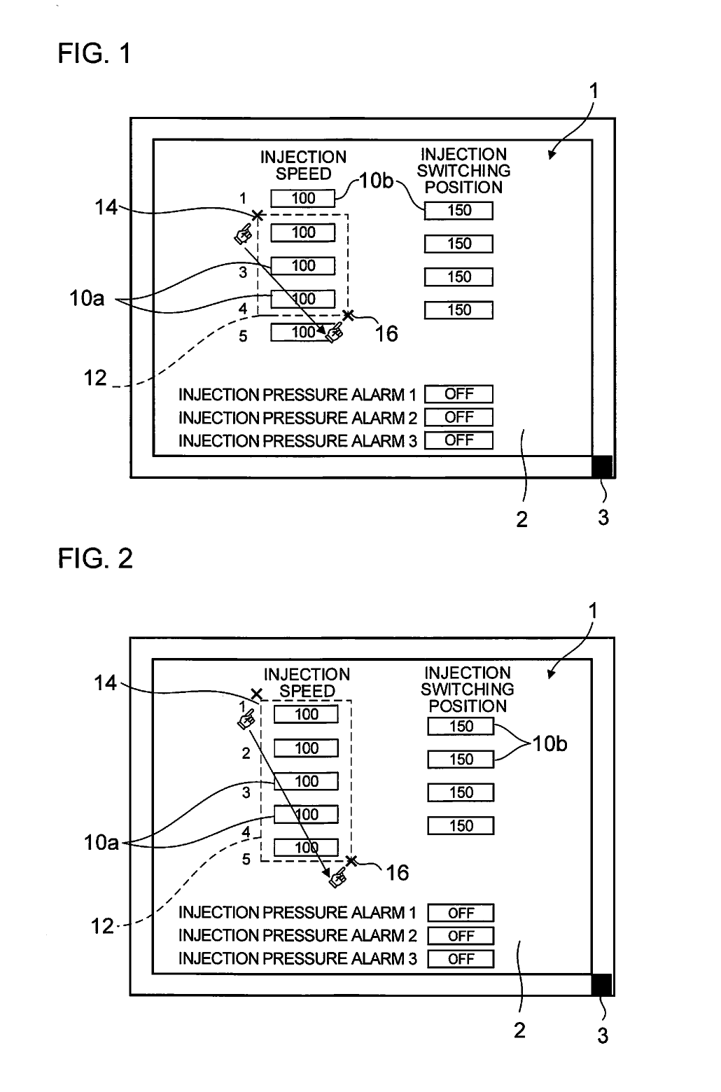

An embodiment of the present invention will now be described with reference to the accompanying drawings. FIG. 1 is a diagram for illustrating a setting item selection method according to the present embodiment. The later-described setting items are displayed on a display device 1. A touch panel 2 is disposed so as to cover the display device 1. An operator performs operation by selecting the item(s) on the touch panel 2 with a finger, pen, or the like. Since a system for detection or operation by the operator's finger, pen, or the like is constructed in the same manner as that of a conventional touch panel, a description thereof will be omitted.

Injection speeds Nos. 1 to 5, injection switching positions between the speeds Nos. 1 to 5, and alarm states of injection pressure alarms 1 to 3 are displayed as setting items 10 on the display device 1. In the state shown in FIG. 1, all the injection speeds Nos. 1 to 5 are set to 100, all the injection switching positions are set to 150, and all the alarm states of the injection pressure alarms 1 to 3 are OFF.

In selecting and collectively setting the injection speeds Nos. 2, 3 and 4, the operator first designates a rectangular shape as the shape of a range. Then, the operator touches a selection start position 14 on the touch panel 2 with a finger; moves the finger to a selection end position 16 while maintaining the contact state, and releases the finger from the touch panel 2 in the selection end position 16. Thereupon, a rectangular shape based on the selection start and end positions 14 and 16 as the apices of its opposite angles is set as a selection range 12. The injection speeds Nos. 2, 3 and 4 included in the selection range 12 are selected as selected setting items 10a. The selected portions are displayed in a different mode, e.g., hatched or changed in color, so that the selection of the selected setting items 10a can be recognized. The remaining or unselected setting items 10 are displayed without change as unselected setting items 10b.

The selection of the setting items 10 is not limited to the above-described method in which the selection start position 14 is touched by the finger and the finger is moved to the selection end position 16 without failing to maintain the contact state and then released from the touch panel 2 in the selection end position 16. Alternatively, for example, the finger may be temporarily brought into contact with and released from the touch panel 2 in the selection start position 14 and then brought again into contact with and released from the touch panel 2 in the selection end position 16. Although the rectangular shape is selected as the shape of the range in the above-described example, moreover, a circular or some other suitable shape may be used as the shape of the range.

FIG. 2 shows an example in which the injection speeds Nos. 1 to 5 are selected as a plurality of setting items. As in the case shown in FIG. 1, the injection speeds Nos. 1 to 5 are selected as the selected setting items 10a by selecting the range that covers the injection speeds Nos. 1 to 5 so that the display mode is changed.

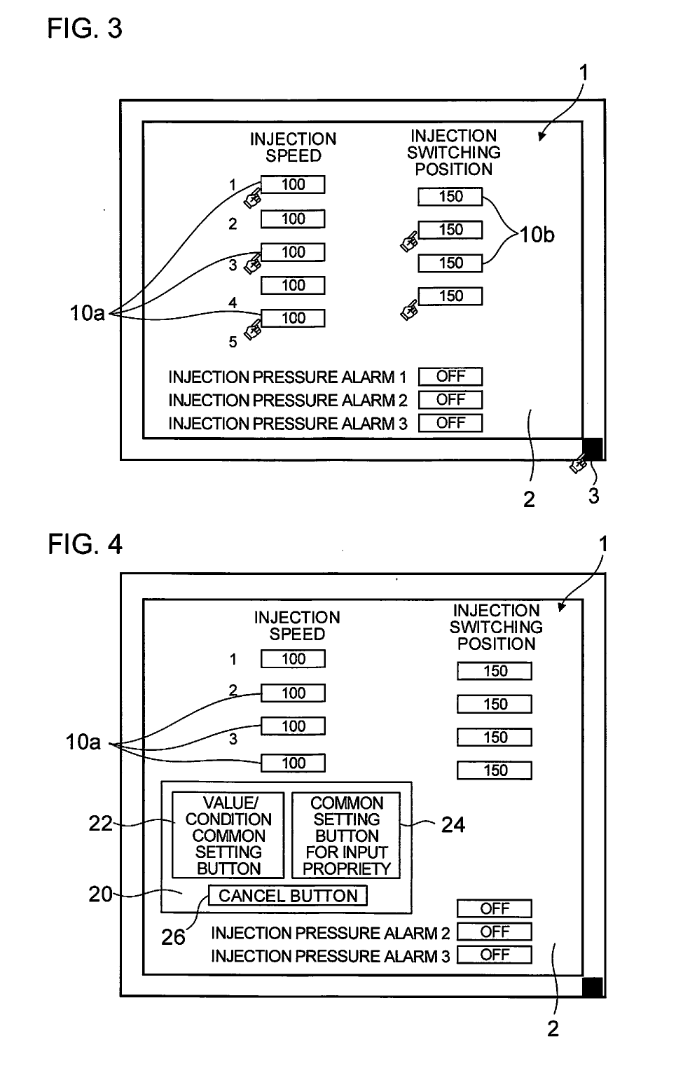

In the methods shown in FIGS. 1 and 2, only those selection items which are adjacent to one another and can be grouped as a block can be selected as a plurality of selection items. According to a method shown in FIG. 3, in contrast, selection items that are located separately can be selected as a plurality of selection items. A setting item selection button 3 is configured to be pressed in selecting the separately located selection items. If the setting items 10 are sequentially pressed and selected with the setting item selection button 3 kept pressed, the separately located selection items can be selected as a plurality of selection items. In the example of FIG. 3, the injection speeds Nos. 1, 3 and 5 and the injection switching positions between Nos. 1 and 2 and between Nos. 4 and 5 are selected so that the display mode for the selected setting items 10a is changed. The setting item selection state can be canceled by sequentially pressing and selecting the setting items 10 after temporarily enabling the setting item selection state by pressing the setting item selection button 3, and thereafter, pressing the setting item selection button again, instead of sequentially selecting the setting items 10 with the setting item selection button 3 kept pressed.

The following is a description of a method for setting values and conditions obtained after the setting items 10 are thus selected as the selected setting items 10a. The setting item selection state is canceled by releasing the finger from the touch panel 2 in the selection end position 16, in the examples of FIGS. 1 and 2, or by releasing the setting item selection button 3 from the pressed state or pressing the setting item selection button 3 again, in the example of FIG. 3. Thereupon, a setting item selection window 20 is displayed, as shown in FIG. 4. A value/condition common setting button 22 is configured to be pressed in setting common values and conditions for the selected setting items 10a. A common setting button 24 for input propriety is configured to be pressed in setting the propriety state for the input of the values and conditions for the selected setting items 10a. If a cancel button 26 is pressed, moreover, the setting is canceled and the setting item selection window 20 is erased. Also, the selection state of the selected setting items 10a is canceled, whereupon the original display mode is restored.

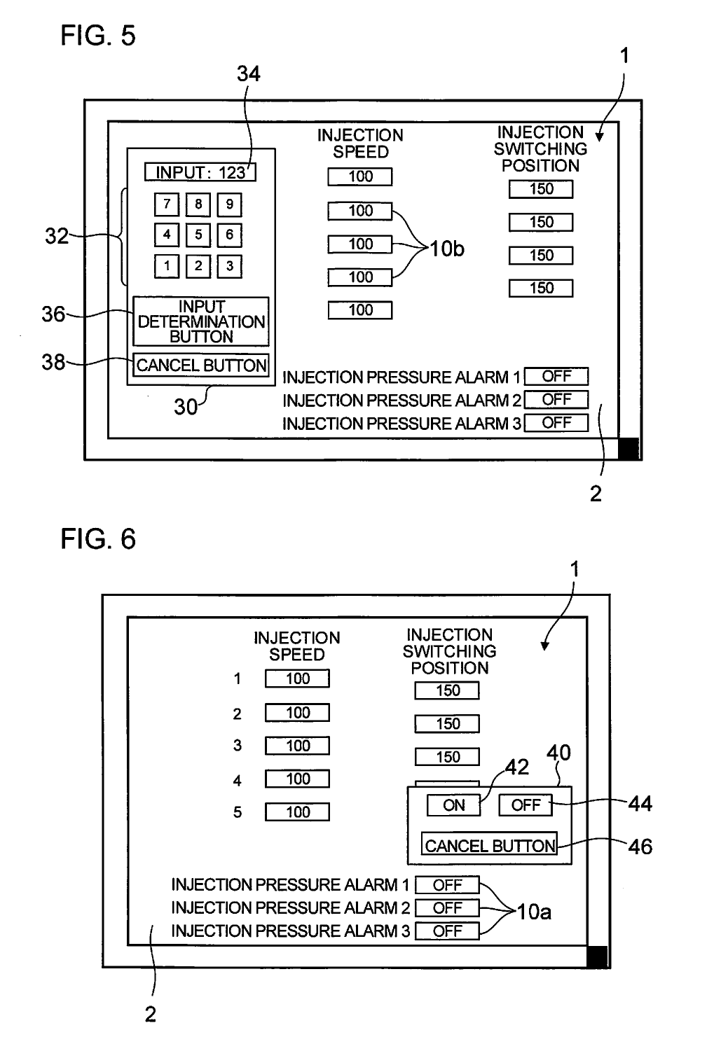

If the setting items 10 for setting numerical values such as the injection speeds and the injection switching positions are set as the selected setting items 10a when the value/condition common setting button 22 is pressed in the state of FIG. 4, a ten-key pad 30 for numerical value setting is displayed in the form of a window, as shown in FIG. 5. Ten-keys 32, display area 34, input determination button 36, and cancel button 38 are displayed as items on the ten-key pad 30 for numerical value setting. Numbers are indicated on the ten-keys 32, which are pressed in inputting a numerical value. The numerical value input by means of the ten-keys 32 are displayed in the display area 34. After the input is completed, the value is determined by pressing the input determination button 36. If the cancel button 38 is pressed, moreover, the value is canceled, the ten-key pad 30 is erased, and the display mode of FIG. 4 is restored.

If a value to be set is input by means of the ten-keys 32 and the input determination button 36 is pressed when the ten-key pad 30 for numerical value setting is displayed, the values of the selected setting items 10a are collectively changed to preset values.

If the setting items 10 for setting conditions such as the injection pressure alarms 1 to 3 are set as the selected setting items 10a when the value/condition common setting button 22 is pressed in the state of FIG. 4, a window 40 for condition setting is displayed, as shown in FIG. 6. An ON button 42, OFF button 44, and cancel button 46 are displayed as items in the window 40 for condition setting. The ON button 42 and the OFF button 44 are used to set an ON or OFF value. If the cancel button 46 is pressed, moreover, the setting is canceled, the window 40 for condition setting is erased, and the display mode of FIG. 4 is restored.

If an ON or OFF signal is input by means of the ON button 42 or the OFF button 44 when the window 40 for condition setting is displayed, the values of the selected setting items 10a are collectively changed to the set ON or OFF value.

If both the setting items 10 for setting the numerical values, such as the injection speeds and the injection switching positions, and the setting items 10 for setting the conditions, such as the injection pressure alarms, are set as the selected setting items 10a (not shown), both the ten-key pad 30 for numerical value setting and the window 40 for condition setting are displayed and the numerical values and the conditions are set collectively.

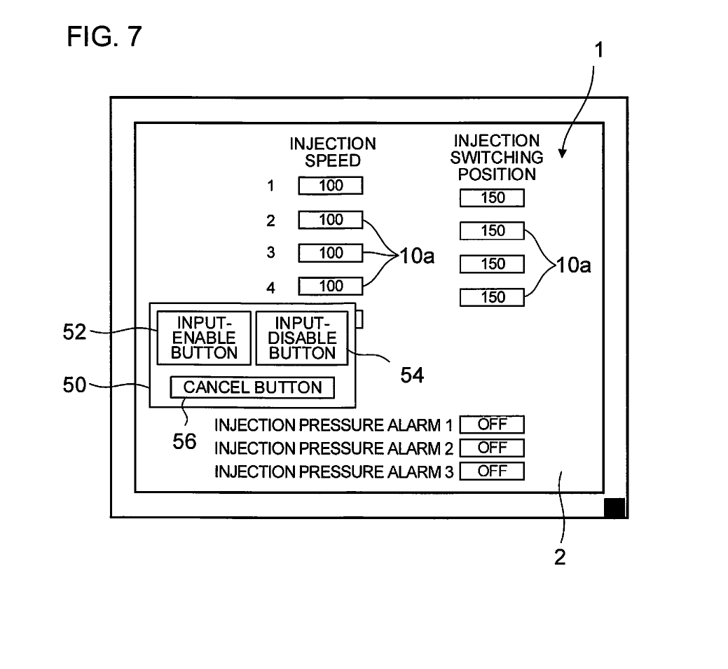

If the common setting button 24 for input propriety is pressed in the state of FIG. 4, a window 50 for input propriety setting is displayed, as shown in FIG. 7. An input-enable button 52, input-disable button 54, and cancel button 56 are displayed as items in the window 50 for input propriety setting. The input-enable button 52 and the input-disable button 54 are used to set the input propriety. If the cancel button 56 is pressed, moreover, the setting is canceled, the window 50 for input propriety setting is erased, and the display mode of FIG. 4 is restored.

If an input-enable signal or an input-disable signal is input by means of the input-enable button 52 or the input-disable button 54 when the window 50 for input propriety setting is displayed, the selected setting items 10a are collectively changed to an input-enable or input-disable state. If the input-disable state is established, the values and the conditions are prohibited from being changed until the input-disable state is canceled thereafter.

1. A setting input means of an injection molding machine configured to set and input setting items by means of a touch panel, the setting input means comprising:
a plural setting item selection means for selecting a plurality of setting items; and
a batch input means capable of collectively inputting one and the same setting state to the plurality of setting items selected by the plural setting item selection means.

2. The setting input means of an injection molding machine according to claim 1, wherein the plural setting item selection means selects the plurality of setting items by designating a range including the plurality of setting items.

3. The setting input means of an injection molding machine according to claim 1, further comprising a setting item selection button, wherein the plural setting item selection means selects, as the plurality of setting items, setting items selected by operating the setting item selection button.

4. The setting input means of an injection molding machine according to claim 1, wherein the one and the same setting state is one value, one condition, and/or one input propriety state.

5. The setting input means of an injection molding machine according to claim 4, comprising a selection means configured to select the one value, the one condition, and/or the one input propriety state as the one and the same setting state.
